(19) United States
(12) Patent Application Publication
(10) Pub. No.: US 2026/0309597 A1
(43) Pub. Date: Oct. 8, 2026

(54) Manufacturing System and Method of Dry Electrode

(71) Applicant: SK On Co., Ltd., Seoul (KR)

(72) Inventors: Yung Sup YOUN, Daejeon (KR); Jun Yeob KIM, Daejeon (KR)

(21) Appl. No.: 19/461,959

(22) Filed: Jan. 28, 2026

(30) Foreign Application Priority Data
Jan. 31, 2025 (KR) 10-2025-0012515

(51) Int. Cl. G01N 3/02; G01N 3/08; G01N 3/24; G01N 11/02; H01M 4/04

(52) U.S. Cl. CPC G01N 3/02; G01N 3/08; G01N 3/24; G01N 11/02; H01M 4/0435

(57) ABSTRACT

The present disclosure provides a system for manufacturing a dry electrode and a method for manufacturing the dry electrode. A system for manufacturing a dry electrode, according to an embodiment, includes an extrusion device forming an electrode fillet by stirring or extruding electrode powder particles; and an analysis device deriving material properties of at least a portion of the electrode fillet formed by the extrusion device, wherein the extrusion device is controlled based on the material properties derived from the analysis device.

### CROSS-REFERENCE TO RELATED APPLICATION(S)

This patent document claims the priority and benefits of Korean Patent Application No. 10-2025-0012515 filed on Jan. 31, 2025, the disclosure of which is incorporated herein by reference in its entirety.

### TECHNICAL FIELD

The disclosure and implementations disclosed in this patent document generally relate to a system for manufacturing a dry electrode and a method for manufacturing the dry electrode.

### BACKGROUND

Secondary batteries, unlike primary batteries, may offer convenience, through being capable of charging and discharging electricity, and are attracting a significant amount of attention as a power source for various mobile devices, electric vehicles, or the like. Unlike primary batteries, secondary batteries may be charged and discharged to be applied to devices having a wide range of applications such as a digital camera, a mobile phone, a laptop, a hybrid vehicle, an electric vehicle, and an energy storage system (ESS).

Such secondary batteries may include a battery cell in which an electrode assembly in which an electrode plate and a separator are stacked is received in a case. A plurality of battery cells may be stacked in a preset direction, and may be received in a battery module or a battery pack. Meanwhile, the electrode plate may be manufactured by coating a slurry including an active material, a conductive material, a binder, a solvent, or the like onto a current collector plate, followed by performing a rolling process, a drying process, and the like. Because this slurry may include moisture, the electrode plate manufactured by applying the slurry may be referred to as a wet electrode.

Since this wet electrode necessarily involves a drying process, manufacturing efficiency thereof may be lower than that of a dry electrode, which does not require the drying process.

### SUMMARY

According to an aspect of the present disclosure, a dry electrode having optimal material properties may be manufactured.

According to an aspect of the present disclosure, a dry electrode may be adjusted to have optimal material properties through real-time feedback control.

A system for manufacturing a dry electrode and a method for manufacturing the dry electrode, of the present disclosure, may be widely applied to green technology fields such as an electric vehicle, a battery charging station, and solar and wind power generation using a battery, or the like, and, furthermore, may be used in an eco-friendly electric vehicle, a hybrid vehicle, or the like to prevent a change in climate by reducing air pollution and greenhouse gas emissions.

A system for manufacturing a dry electrode, according to an embodiment of the present disclosure, includes an extrusion device forming an electrode fillet by stirring or extruding electrode powder particles; and an analysis device deriving material properties of at least a portion of the electrode fillet formed by the extrusion device, wherein the extrusion device is controlled based on the material properties derived from the analysis device.

According to an embodiment, the extrusion device may include an inlet introducing the electrode powder particles into an internal space, a screw member stirring or pressurizing the introduced electrode powder particles into the internal space to form the electrode fillet, and an outlet discharging the electrode fillet.

According to an embodiment, the analysis device may be structured to be connected to the outlet to introduce at least a portion of the electrode fillet, and structured to derive the material properties of the introduced electrode fillet.

According to an embodiment, the analysis device may apply at least one type of force among shear stress or normal stress to the electrode fillet, to derive the material properties of the electrode fillet.

According to an embodiment, the analysis device may include a material-receiving portion into which the electrode fillet is introduced; and a material-pressurizing portion structured to press the electrode fillet received in the material-receiving portion.

According to an embodiment, the material-pressurizing portion may be structured to advance toward the material-receiving portion to apply the normal stress to the electrode fillet and, while rotating in that state, to apply the shear stress to the electrode fillet.

In an embodiment, the material properties of the electrode fillet derived from the analysis device may include at least one of a flow function (F.F.) value or a cohesion value of the electrode fillet.

In an embodiment, at least one of a temperature of the internal space of the extrusion device or RPM (rotations per minute) of a screw member provided in the extrusion device may be controlled, based on the material properties.

In an embodiment, when the flow function value of the electrode fillet derived from the analysis device exceeds 2.5, at least one of the temperature of the internal space of the extrusion device or the RPM of the screw member may increase.

In an embodiment, when the cohesion value of the electrode fillet derived from the analysis device is less than 3 kPa, at least one of the temperature of the internal space or the RPM of the screw member may increase.

According to an embodiment, when the cohesion value of the electrode fillet derived from the analysis device exceeds 50 kPa, at least one of the temperature of the internal space or the RPM of the screw member may decrease.

According to an embodiment, the system may further include a roller part rolling the electrode fillet discharged from the outlet, wherein the electrode fillet discharged from the outlet may be structured to be provided, together to the roller part and the analysis device.

A method for manufacturing a dry electrode, according to an embodiment of the present disclosure, includes a powder particles-introducing operation of introducing electrode powder particles including a binder into an extrusion device; a powder particles-mixing and extruding operation of stirring and compressing the introduced electrode powder particles to form an electrode fillet; an analyzing operation of analyzing material properties of the electrode fillet; and a control operation of controlling the extrusion device, based on the material properties derived from the analyzing operation.

According to an embodiment, the analyzing operation may include a flowability-analyzing operation of analyzing whether a flow function value of the electrode fillet falls within a preset range; and a cohesion-analyzing operation of analyzing whether a cohesion value of the electrode fillet falls within a preset range.

In an embodiment, the preset range of the flow function value may be 2.5 or less.

In an embodiment, the preset range of the cohesion value may be 3 kPa or more.

In an embodiment, the control operation may feedback-control the extrusion device when the electrode fillet does not satisfy the preset range.

In an embodiment, the flowability-analyzing operation may increase at least one of a temperature of an internal space of the extrusion device or RPM of a screw member of the extrusion device, when the flow function value of the electrode fillet exceeds 2.5.

In an embodiment, the cohesion-analyzing operation may increase at least one of a temperature of an internal space of the extrusion device or RPM of a screw member of the extrusion device, when the cohesion value of the electrode fillet is less than 3 kPa.

In an embodiment, the flowability-analyzing operation may apply normal stress and shear stress to the electrode fillet, and derive the flow function value based on normal stress and shear stress when the electrode fillet begins to flow in a direction of the shear stress.

Solutions to be overcome according to the present disclosure have been described above, but are merely illustrative, and should be understood that other configurations not mentioned herein are also included within the scope of the present disclosure.

### BRIEF DESCRIPTION OF DRAWINGS

Certain aspects, features, and advantages of the present disclosure may be illustrated by the following detailed description with reference to the accompanying drawings.

FIG. 1 is a view schematically illustrating a system for manufacturing a dry electrode according to an embodiment of the present disclosure.

FIG. 2 is a view schematically illustrating an analysis device according to an embodiment of the present disclosure.

FIG. 3 is a view schematically illustrating a process of deriving material properties of a mixture using an analysis device.

FIG. 4 is a flowchart of a method for manufacturing a dry electrode according to an embodiment of the present disclosure.

FIG. 5 is an experimental graph illustrating material properties of a mixture derived from an analysis device.

### DETAILED DESCRIPTION

Before describing the present disclosure in detail, it should be noted that the terms and words used in the specification and claims described below should not be construed as limited to their conventional or dictionary meanings, and, rather, should be interpreted in their meanings and concepts consistent with the technical spirit of the present disclosure, based on the principle that the inventor may appropriately define the concepts of terms to best describe his or her invention.

Identical reference numbers or symbols in each of the drawings indicate components or elements that perform substantially the same functions. For convenience of explanation and understanding, the same reference numbers or symbols may be used in different embodiments.

In the following description, Singular expressions may include plural expressions unless the context clearly dictates otherwise. Terms such as “comprise,” “include,” “have,” or the like indicate the presence of a feature, a numeral, a step, an operation, a component, a part, or combination thereof described in the specification, but should be understood as not excluding possibility of the presence or addition of one or more other features, numbers, steps, operations, components, parts, or combinations thereof.

Furthermore, in the following description, terms such as “on,” “upper side,” “upper portion,” “below,” “lower side,” “lower portion,” “side surface,” “front surface,” “rear surface,” and the like may be expressed based on the orientation depicted in the drawings, and may be expressed differently when the orientation of the object changes.

Furthermore, terms including ordinal numbers, such as “first,” “second,” and the like, may be used to distinguish between components in the following description and claims. These ordinal numbers may be used to distinguish identical or similar components from each other, and use of such ordinal numbers should not be interpreted in a limited manner. For example, components associated with such ordinal numbers should not be interpreted in a restricted manner, such as in the order of use or arrangement. As necessary, each ordinal number may be used interchangeably.

Hereinafter, the present disclosure will be described in detail with reference to the drawings.

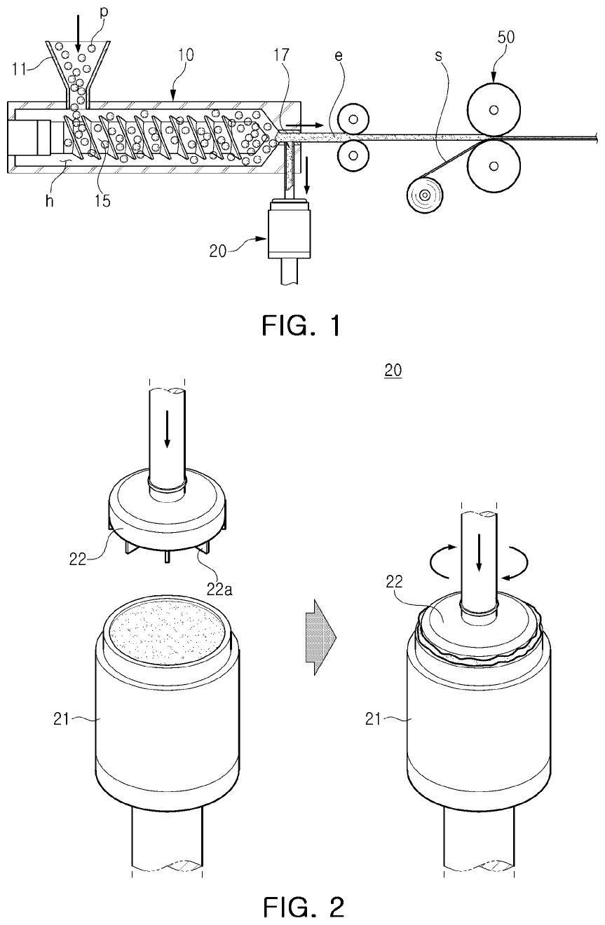

FIG. 1 is a view schematically illustrating a system for manufacturing a dry electrode according to an embodiment of the present disclosure.

A system 1 for manufacturing a dry electrode according to an embodiment of the present disclosure may include an extrusion device 10 forming an electrode fillet (e) by stirring or extruding electrode powder particles p, and an analysis device 20 analyzing the electrode fillet (e) to control the extrusion device 10.

Before describing the present disclosure in detail, the ‘dry electrode’ described in the present disclosure will be described. An electrode (a wet electrode), in contrast to the dry electrode, may be formed by stirring a mixture including an active material, a conductive material, a binder, and a liquid solvent to form a slurry, applying the slurry to a current collector sheet, and then rolling and drying the same to form the electrode. In contrast, the dry electrode described in the present disclosure may not use the liquid solvent, or may not actually use the liquid solvent. For example, the electrode powder particles of a dry particle form including the active material, the conductive agent, and the binder may be mixed and formed into a film form or a fillet form, which may then be laminated on a current collector sheet or an electrode current collector. In this manner, the dry electrode may be formed into a film by forming a web-like fiber network through a fibrillation process during the stirring process or the pressing process.

In this manner, the process of the dry electrode may eliminate the need for, or substantially eliminate, a drying process by using the binder that does not require, or substantially eliminates, the solvent. For example, the binder used in the dry electrode may include polytetrafluoroethylene (PTFE). PTFE may not require the solvent and, when stirred or pressed, fiberizes into a web-like structure, allowing the active material and the conductive agent to adhere to each other and coagulate. In this manner, when the electrode powder particles are spread thinly to an appropriate thickness through a roller in a tangled state, an electrode film may be formed, and may be calendered or laminated onto a current collector sheet or a current collector plate to manufacture an electrode plate.

In a process of manufacturing the dry electrode, appropriately maintaining a degree of fiberization, e.g., a degree of coagulation, of the electrode powder particles may be an important factor in determining a quality of the dry electrode. For example, a quality of the electrode fillet (e) discharged from the extrusion device 10 may be changed depending on the degree of fiberization of the electrode powder particles (p) in the extrusion device 10. When the degree of fiberization of the electrode powder particles (p) is excessively high, or when the degree of coagulation is excessively high, cracks may occur when the manufactured electrode fillet (e) is processed into the film. When the degree of fiberization of the electrode powder particles (p) is excessively low, or when the degree of coagulation is excessively low, the manufactured electrode fillet (e) may be difficult to laminate to the current collector sheet, difficult to σ form the electrode sheet, or difficult to process into a film.

A system 1 for manufacturing a dry electrode of the present disclosure may control the extrusion device 10 in real time via the analysis device 20, thereby ensuring the electrode fillet (e) discharged from the extrusion device 10 possesses optimal material properties. This may simultaneously improve quality and production efficiency.

In this case, the “material properties of the electrode fillet e” may be factors considered when measuring or analyzing the degree of fiberization of the electrode powder particles (p) described above, and may include at least one of a “flow function (F.F)” or “cohesion” of the electrode fillet e. For example, the present disclosure may control the extrusion device 10 in the analysis device 20 in a feedback manner by considering at least one of the flow function (F.F) or the cohesion. According to an embodiment, a system 1 for manufacturing a dry electrode of the present disclosure may control at least one of a temperature of an internal space (h) of the extrusion device 10 or RPM (rotations per minute) of a screw member 15, based on the material properties derived from the analysis device 20. Through this, the flow function (F. F.) and cohesion of the electrode fillet (e) may be optimally maintained. More details about this will be described later.

A system 1 for manufacturing a dry electrode according to an embodiment of the present disclosure may include an extrusion device 10 forming an electrode fillet (e) by stirring or extruding electrode powder particles p, and an analysis device 20 analyzing material properties of at least a portion of the electrode fillet (e) formed in the extrusion device 10, wherein the extrusion device 10 may be controlled based on the material properties derived from the analysis device 20.

The extrusion device 10 may include an inlet 11 into which the electrode powder particles (p) are introduced, a screw member 15 stirring or pressurizing the electrode powder particles (p) introduced into an internal space (h) to form the electrode fillet (e), and an outlet 17 through which the electrode fillet (e) is discharged.

The inlet 11 may be a portion into which the electrode powder particles (p) are introduced, and may include a hopper into which a mixture is introduced. However, the present disclosure is not limited thereto, and a component into which the electrode powder particles (p) are introduced may be referred to as the inlet 11. The “electrode powder particles (p)” may include particles such as an electrode active material or the like, and a binder forming a fiber. However, the “electrode powder particles (p)” described in the present disclosure are not limited thereto, and may include any mixture introduced into the extrusion device 10 described above.

The screw member 15 may form the electrode fillet (e) by stirring and/or extruding the electrode powder particles (p) introduced into the internal space (h). The screw member 15 may rotate in the internal space (h), and may transfer the electrode powder particles (p) to one side toward the outlet 17 while stirring and/or compressing the electrode powder particles (p). In this case, ‘stirring’ may mean including mixing the electrode powder particles (p) in the internal space (h). In this case, ‘extrusion’ may mean including applying pressure to the electrode powder particles (p) to coagulate the electrode powder particles (p). For example, the stirred or compressed electrode powder particles (p) may be fiberized and coagulated into a lump-shape, and may be processed into a film shape by being thinly spread by a roller.

The outlet 17 may discharge the electrode fillet (e) formed by stirring or compressing the electrode powder particles (p). In this case, the term “electrode fillet (e)” may encompass all forms in which the electrode powder particles (p) are processed into a film by being fiberized and coagulated, or by being thinly spread out. For example, any configuration passing through the extrusion device 10 and to be discharged may be referred to as the “electrode fillet (e)” of the present disclosure, and it should be understood that the configuration is not limited to a chemical composition, a degree of fiberization, or the like.

According to an embodiment, the analysis device 20 may be connected to the outlet 17, and structured to receive at least a portion of the electrode fillet (e) and analyze material properties of the electrode fillet (e) that has been introduced. A system 1 for manufacturing a dry electrode according to an embodiment may control the extrusion device 10 based on material properties derived from the analysis device 20.

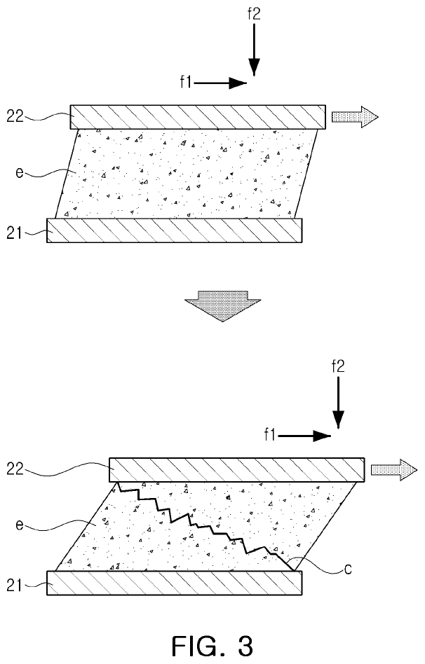

As described later in FIGS. 2 and 3, the analysis device 20 may derive or analyze the material properties of the electrode fillet (e) by applying at least one of shear stress f1 or normal stress f2 to at least a portion of the electrode fillet (e) discharged from the extrusion device 10.

In addition, a system 1 for manufacturing a dry electrode according to an embodiment of the present disclosure may further include a roller part 50. The roller part 50 may thinly spread the electrode fillet (e) discharged from the extrusion device 10 to a preset thickness by calendering. In addition, the roller part 50 may laminate the electrode fillet (e) to a current collecting sheet s. For example, the roller part 50 may form an electrode sheet by rolling the electrode fillet e.

Specifically, according to an embodiment, the system may further include a roller part 50 rolling the electrode fillet (e) discharged from the outlet 17, and the electrode fillet (e) discharged from the outlet 17 may be structured to be provided together to the roller part 50 and the analysis device 20. For example, while manufacturing of the dry electrode by the roller part 50, and analysis by the analysis device 20 may be performed simultaneously, the material properties of the electrode fillet (e) may be adjusted by real-time feedback to the extrusion device 10, based on the material properties derived from the analysis device 20.

In this manner, according to an embodiment of the present disclosure, a portion of the electrode fillet (e) discharged from the extrusion device 10 may be transported toward the roller part 50 and attached to the current collecting sheet(s), and a remaining portion may be transported to the analysis device 20 such that the material properties may be analyzed by the analysis device 20. Through this, a system 1 for manufacturing a dry electrode of the present disclosure may optimally maintain the material properties of the electrode fillet (e) discharged from the extrusion device 10 without stopping a production facility, through the analysis device 20 analyzing the material properties of the electrode fillet (e) in real time and feedback-controlling the extrusion device 10 accordingly.

The “material properties of the electrode fillet (e)” herein may be factors considered when measuring or analyzing a degree of fiberization of the electrode powder particles (p), as described above. According to an embodiment, the electrode fillet (e) may include characteristics of powder flow because the electrode powder particles (p) may be formed in an aggregated form. Therefore, the material properties of the electrode fillet (e) may include flowability, cohesion, or the like of the electrode fillet (e), and may refer to at least one value of “flow function (F.F)” or “cohesion.” Hereinafter, the analysis device 20 of the present disclosure will be described with reference to the drawings.

FIG. 2 is a view schematically illustrating an analysis device according to an embodiment of the present disclosure, and FIG. 3 is a view schematically illustrating a process of deriving material properties of a mixture using an analysis device. FIG. 2 is a view schematically illustrating an analysis device 20 of the present disclosure, and FIG. 3 is a view schematically illustrating analysis of material properties of an electrode fillet (e) using an analysis device 20 of the present disclosure.

Referring to FIG. 2, an analysis device 20 may include a material-receiving portion 21 receiving an electrode fillet (e) discharged from an extrusion device 10, and a material-pressurizing portion 22 pressurizing the electrode fillet (e) received in the material-receiving portion 21. Referring again to FIG. 1, the analysis device 20 may be connected to an outlet 17 of the extrusion device 10, and may be provided such that the electrode fillet (e) stirred or pressed through a screw member 15 and in a coagulated state is introduced. The analysis device 20 may analyze material properties of the electrode fillet (e) being discharged in real time, and may control the extrusion device 10 based thereon to ensure that the electrode fillet (e) has optimal cohesion or flowability. In this manner, the present disclosure may simultaneously perform manufacturing and analysis of the dry electrode without a separate delay for analysis, while ensuring optimal material properties.

An analysis device 20 according to an embodiment of the present disclosure may analyze the material properties by pressing and rotating the electrode fillet (e). According to an embodiment, the material-pressurizing portion 22 may move toward the material-receiving portion 21 to apply normal stress f2 (see FIG. 3) and, while rotating in that state, apply shear stress f1 (see FIG. 3). Specifically, as illustrated in the drawings, the material-pressurizing portion 22 may apply normal stress f2 (see FIG. 3) while pressing the electrode fillet (e) downward, and apply shear stress f1 (see FIG. 3) while rotating. An analysis device 20 according to an embodiment of the present disclosure may include at least one protrusion 22a protruding from a lower end of the material-pressurizing portion 22 toward the material-receiving portion 21. The protrusion 22a may be structured to be embedded in the electrode fillet (e) received in the material-receiving portion 21, such that shear stress f1 may be more effectively applied to the electrode fillet (e) when the material-pressurizing portion 22 rotates. In this manner, the analysis device 20 may measure at least one of a flow function value (F. F value) or a cohesion value of a material (electrode fillet (e)) received in the material-receiving portion 21 while applying both normal stress f2 and shear stress f1 to the material (electrode fillet; e).

Referring to FIG. 3, an analysis device 20 may be structured to apply both normal stress f2 and shear stress f1. Specifically, the analysis device 20 may apply the shear stress f1 while a material-pressurizing portion 22 rotates while applying the normal stress f2 within a preset range. According to an embodiment, the analysis device 20 may measure material properties of an electrode fillet (e) by gradually increasing a magnitude of the shear stress f1 through rotation while applying the normal stress f2 to the electrode fillet (e). In this case, the material properties of the electrode fillet (e) may include at least one of a flow function value or a cohesion value, as described above.

Specifically, according to an embodiment, the electrode fillet (e) may have powder flow characteristics. Therefore, the analysis device 20 may obtain the value of the flow function (F. F) through the following Mathematical Equation:

$$F . F = \frac{{σ}_{p}}{{σ}_{y}} \qquad [ Mathematical Equation 1 ]$$

“σₚ” may be major principal stress applied to a material, and may be normal stress applied to a surface on which shear stress is 0, and “σ_{y}” may be unconfined yield stress, and may be shear stress when an electrode fillet (e) starts to flow. For example, as illustrated in FIG. 3, the analysis device 20 may apply normal stress f2 and shear stress f1 to the electrode fillet (e) through the material-pressurizing portion 22, and derives a value of the normal stress f2 at a moment when the electrode fillet (e) starts to flow (for example, a moment when a crack (c) is generated in the electrode fillet (e) in a cohesive state) as the major principal stress (Op), and the shear stress f1 at that time may be derived as the yield stress (Oy). Through this, the value of the flow function may be obtained. However, this is may be an example for the convenience of understanding, and even when a crack (c) does not occur, the value of the flow function may be obtained when the electrode fillet (e) begins to flow.

According to an embodiment of the present disclosure, the analysis device 20 may derive the value (material property) of the flow function (F. F) of the electrode fillet e, and may determine whether the value of the flow function (F.F) falls within a preset range. As the value of the flow function (F.F) increases, flowability may increase, and as the value decreases, flowability may decrease. The flow function (F. F) may be inversely proportional to the cohesion, which will be described later. For example, as the value of the flow function (F.F) increases, the cohesion value of an object may decrease, and as the value of the flow function (F.F) decrease, the cohesion value of the object may increase.

According to an embodiment, a system 1 for manufacturing a dry electrode may control the flow function value (F.F. value) of the electrode fillet (e) to maintain a value of 2.5 or less. Specifically, the analysis device 20 may determine whether the flow function value (F.F. value) is greater than 0 and 2.5 or less.

When the flow function value (F.F. value) of the electrode fillet (e) is 2.5 or less, cohesion between an active material, a conductive material, and a binder of electrode powder particles (p) may increase (i.e., appropriate fiberization occurs) to increase tensile strength of an electrode when rolled onto a current collector sheet(s) by calendering. This may reduce occurrence of defects such as cracks, pinholes, and the like in the dry electrode, and may improve quality. When the value of the flow function (F.F) of the electrode fillet (e) exceeds 2.5, flowability may excessively increase, making it difficult to process the electrode fillet (e) into a film shape, and problems such as cracks, pinholes, and the like occurring after calendering may be generated.

Therefore, a system 1 for manufacturing a dry electrode of the present disclosure may increase RPM of a screw member 15 or a temperature of an internal space (h) of an extrusion device 10 to further enhance fiberization of the electrode powder particles (p) when the flow function value (F.F. value) of the electrode fillet (e) exceeds 2.5. For example, in this case, the system 1 for manufacturing a dry electrode may increase at least one of the temperature of the internal space (h) or the RPM of the screw member 15.

In addition, the analysis device 20 of the present disclosure may obtain the value of cohesion through the normal stress f2 and the shear stress f1. Cohesion may be a value that describes a degree to which the electrode fillet (e) tends to clump or disperse. As the cohesion value becomes closer to 0, the more likely the electrode fillet (e) is to disperse. Therefore, the cohesion value may be inversely proportional to the value of the flow function (F. F).

For example, according to the present disclosure, the cohesion value may be measured by applying normal stress f2 to the electrode fillet (e) in which the material-pressurizing portion 22 of the analysis device 20 is received in the material-receiving portion 21, and applying then shear stress f1 while rotating in a state in which a constant normal stress f2 is continuously applied. In this case, the rotation of the material-pressurizing portion 22 may be performed by a separate motor (not illustrated), and the cohesion value may be measured by measuring the load ratio of the motor applied here. As another example, according to the present disclosure, the analysis device 20 may obtain values of the stresses f1 and f2 and the flow function (F. F), described above, through Mohr-Coulomb theory. For example, a cohesion value of the present disclosure may be obtained by the following Mathematical Equation:

$$Cohesion = τ - σ \cdot tan ( φ ) \qquad [ Mathematical Equation 2 ]$$

τ may be shear stress and may be f1 described above, σ may be normal stress and may be f2 described above, and σ may be internal friction angle and may be a coefficient that may be changed, depending on characteristics of powder particles (material).

According to an embodiment of the present disclosure, the analysis device 20 may derive a cohesion value of the electrode fillet (e), and may determine whether the cohesion value falls within a preset range. As described below, when the cohesion value of the electrode fillet (e) does not fall within the preset range, the cohesion value of the electrode fillet (e) may be adjusted to fall within the preset range by adjusting control factors such as the RPM and/or temperature of the extrusion device 10.

Specifically, according to an embodiment, a system 1 for manufacturing a dry electrode may be controlled such that the cohesion value of the electrode fillet (e) may be maintained at 3 kPa or more. Specifically, the analysis device 20 may determine whether the cohesion value falls within a range of 3 kPa or more.

When the cohesion value of the electrode fillet (e) is 3 kPa or more, cohesion between the active material, the conductive material, and the binder of the electrode powder particles (p) may increase (i.e., fiberization occurs appropriately), allowing formation of an electrode sheet during calendering. When the cohesion value of the electrode fillet (e) is less than 3 kPa, fluidity of the electrode fillet (e) may increase excessively, making it difficult to process the electrode fillet (e) into a film, and cracks or pinholes may subsequently occur.

As described below, a system 1 for manufacturing a dry electrode of the present disclosure may increase the RPM of the screw member 15 of the extrusion device 10 and/or increase the temperature of the extrusion device 10 when the cohesion value of the electrode fillet (e) is less than 3 kPa in the analysis device 20.

Furthermore, according to an embodiment, a system 1 for manufacturing a dry electrode may control the cohesion value of the electrode fillet (e) to be maintained at 50 kPa or less. When the cohesion value exceeds 50 kPa, defects such as cracks, pinholes, and the like may occur in the dry electrode.

Specifically, the analysis device 20 may determine whether the cohesion value falls within a range of 50 kPa or less. A system 1 for manufacturing a dry electrode of the present disclosure may reduce the RPM of the screw member 15 of the extrusion device 10 or/and the temperature of the extrusion device 10 when the analysis device 20 determines that the cohesion value of the electrode fillet (e) exceeds 50 kPa. For example, a system 1 for manufacturing a dry electrode according to an embodiment may adjust the extrusion device 10 such that the cohesion value of the electrode fillet (e) falls within a range of 3 kPa or more and 50 kPa or less.

A system 1 for manufacturing a dry electrode of the present disclosure is not limited to upper limits, as described above, and any system controlling and regulating the extrusion device 10 such that the cohesion value of the electrode fillet (e) is 3 kPa or more may be considered to belong to the present disclosure. For example, when the cohesion value is less than 3 kPa, it may be difficult to form an electrode sheet, so the present disclosure should be considered to belong to the present disclosure so long as the extrusion device 10 is adjusted such that the cohesion value of the electrode fillet (e) does not fall less than 3 kPa, and an upper limit of the cohesion value is not limited. Therefore, a system 1 for manufacturing a dry electrode of the present disclosure may increase the RPM of the screw member 15 or increase the temperature of the internal space (h) of the extrusion device 10, to further increase fiberization of the electrode powder particles (p) when the cohesion value of the electrode fillet (e) is less than 3 kPa. For example, in this case, the system 1 for manufacturing a dry electrode may increase at least one of the temperature of the internal space (h) or the RPM of the screw member 15.

Hereinafter, a method for manufacturing a dry electrode according to an embodiment of the present disclosure will be described.

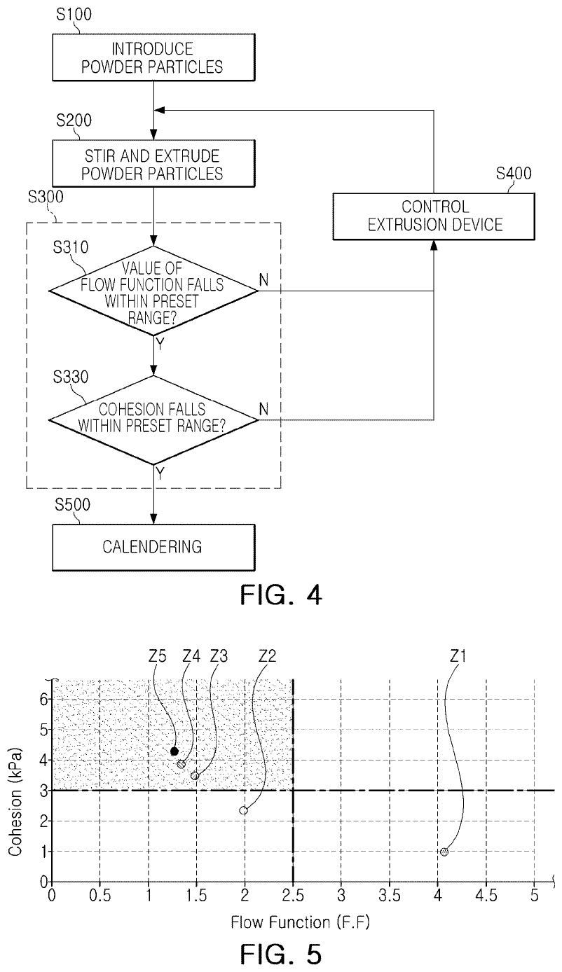

FIG. 4 is a flowchart of a method for manufacturing a dry electrode according to an embodiment of the present disclosure. Hereinafter, the method for manufacturing a dry electrode of the present disclosure will be described with reference to the drawings, but contents overlapping the contents described above in FIGS. 1 to 3 will be omitted.

A method for manufacturing a dry electrode according to an embodiment of the present disclosure may include a powder particles-introducing operation (S100) of introducing electrode powder particles (p) including a binder into an extrusion device 10, a powder particles-extruding operation (S200) of stirring and compressing the electrode powder particles (p) introduced into the extrusion device 10 to form an electrode fillet (e), an analysis operation (S300) of analyzing material properties of the electrode fillet (e), and an extrusion device-controlling operation (S400) of controlling the extrusion device 10 based on the material properties derived from the analyzing operation.

The powder particles-introducing operation (S100) may include introducing the electrode powder particles (p) into the extrusion device 10. Referring also to FIG. 1, the powder particles-introducing operation (S100) may include introducing the electrode powder particles (p) into an inlet 11 of the extrusion device 10.

The powder particles-extruding operation (S200) may include stirring or extruding the electrode powder particles (p) introduced into an internal space (h) through a screw member 15 of the extrusion device 10. As described above, the electrode powder particles (p) may include a dry binder that becomes fiberized and sticks together when stirred or extruded at a preset temperature. Through this, in the powder particles-extruding operation (S200), the electrode powder particles (p) may be formed in an aggregated state by stirring or pressing.

The analysis operation (S300) may include at least one of a flowability-analyzing operation (S310) or a cohesion-analyzing operation (S320). Hereinafter, the present disclosure will be described as including both (S310 and S320), but even when only one operation is included, it will still fall within the analysis operation (S300) of the present disclosure. Furthermore, according to an embodiment, a sequence of the flowability-analyzing operation (S310) and the cohesion-analyzing operation (S320) may be irrelevant. According to an embodiment, the analysis operation (S300) may include a flowability-analyzing operation (S310) of analyzing whether a value of the flow function (F. F.) of the electrode fillet (e) falls within a preset range, and a cohesion-analyzing operation (S320) of analyzing whether the cohesion value of the electrode fillet (e) falls within a preset range.

In this case, as described above, the preset range of the flow function value (F. F), which serves as a judgment criterion of the flowability-analyzing operation (S310), may be 2.5 or less. Specifically, the preset range of the flow function value (F.F value) may be greater than 0 and less than or equal to 2.5.

In this case, as described above, the preset range of the cohesion value, which serves as a judgment criterion of the cohesion-analyzing operation (S320), may be 3 kPa or more. Specifically, according to an embodiment, the preset range of the cohesion value, which serves as a judgment criterion of the cohesion-analyzing operation (S320), may be 3 kPa or more and 50 kPa or less.

According to an embodiment of the present disclosure, the control (S300) may feedback-control the extrusion device 10 when the material properties of the electrode fillet (e) do not fall within the preset range. Specifically, according to an embodiment, when at least one of the flowability-analyzing operation (S310) or the cohesion-analyzing operation (S320) does not satisfy the preset range (S310; N and S320; N), at least one of the RPM of the screw member 15 of the extrusion device 10 or the temperature of the extrusion device 10 may be controlled.

More specifically, when the value of the flow function (F.F) of the electrode fillet (e) derived in the flowability-analyzing operation (S310) exceeds 2.5, at least one of the temperature of the internal space (h) of the extrusion device 10 or the RPM of the screw member 15 may increase. In addition, when the cohesion value of the electrode fillet (e) is less than 3 kPa, the cohesion-analyzing operation (S320) may increase at least one of the temperature of the internal space (h) of the extrusion device 10 or the RPM of the screw member 15 of the extrusion device 10.

Also, as described above, referring back to FIG. 3, the flowability-analyzing operation (S310) may apply normal stress f2 and shear stress f1 to the electrode fillet (e), and the flow function (F.F) may be derived based on the normal stress 12 and the shear stress f1 when the electrode fillet (e) flows in a direction in which the shear stress f1 acts.

Hereinafter, with reference to the drawings, an electrode fillet (e) having optimal material properties based on various experimental values will be described in detail.

FIG. 5 is an experimental graph illustrating material properties of a mixture derived from an analysis device.

According to an embodiment of the present disclosure, material properties of an electrode fillet (e) may be adjusted in real time through real-time feedback based on material properties derived from an analysis device 20.

Referring to FIG. 5, material properties of Experimental Example 1 (Z1), Experimental Example 2 (Z2), Experimental Example 3 (Z3), Experimental Example 4 (Z4), and Experimental Example 5 (Z5) are illustrated. Table 1 below presents numerical values of specific material properties. Shaded portions in a graph of FIG. 5 represent Experimental Examples Z3, Z4, and Z5 that satisfy the specified material properties described above.

TABLE 1

| | Experimental | Experimental | Experimental | Experimental | Experimental |
|---|---|---|---|---|---|
| | Ex. 1 (Z1) | Ex. 2 (Z2) | Ex. 3 (Z3) | Ex. 4 (Z4) | Ex. 5 (Z5) |
| Cohesion (kPa) | 1.03 | 2.394 | 3.52 | 3.89 | 4.30 |
| Flow Function | 4.06 | 1.993 | 1.48 | 1.36 | 1.27 |
| (F · F) | | | | | |
| Yield Stress | 3.70 | 9.09 | 14.14 | 15.97 | 18.03 |
| (σ_{y}, kPa) | | | | | |

As illustrated in the table above, in Experimental Example 1 (Z1), a cohesion value is less than 3 kPa (S320, N) and a flow function value (F.F. value) exceeds 2.5 (S310, N). Therefore, (S400) of adjusting the extrusion device 10 as described above may be performed. The electrode fillet (e) manufactured in Experimental Example 1 (Z1) may have relatively poor quality because fluidity and flowability increase as described above, causing cracks.

In Experimental Example 2 (Z2), a flow function value (F.F. value) is 2.5 or less (S310, Y), but a cohesion value is less than 3 kPa (S320, N). Therefore, the extrusion device 10 may be adjusted as described above (S400). The electrode fillet (e) manufactured in Experimental Example 2 (Z2) may also have relatively poor quality, similar to Experimental Example 1 (Z1).

Experimental Example 3 (Z3), Experimental Example 4 (Z4), and Experimental Example 5 (Z5) have a cohesion value of 3 kPa or more and a flow function value (F. F. value) of 2.5 or less. Experimental Example 3 (Z3) to Experimental Example 5 (Z5) may correspond to embodiments of the present disclosure. In FIG. 4, the flowability-analyzing operation (S310) may be passed (S310, Y) and the flowability-analyzing operation (S320, Y), allowing subsequent processes (e.g., calendering operation (S500)) to be performed.

The present disclosure allows the calendering operation (S500) and the control operation (S400) to be performed together. For example, referring to FIG. 5, Experimental Example 1 (Z1) may represent material properties of an electrode fillet (e) initially manufactured through an extrusion device 10. Through the control operation (S400), Experimental Example 2 (Z2) had a flow function value (F.F. value) adjusted to less than 2.5, unlike Experimental Example 1 (Z1). Through the control operation (S400), Experimental Example 3 (Z3) can be seen to have the flow function values (F.F. values) and cohesion values satisfying the aforementioned preset ranges, unlike Experimental Example 2 (Z2).

In this manner, according to an embodiment, the extrusion device 10 may be adjusted such that the material properties of the electrode fillet (e) satisfy the preset ranges by repeating the control operation (S400).

A system for manufacturing a dry electrode and a method for manufacturing the dry electrode, according to an embodiment of the present disclosure, may manufacture a dry electrode having optimal material properties.

A system for manufacturing a dry electrode and a method for manufacturing the dry electrode, according to an embodiment of the present disclosure, may adjust the dry electrode to have optimal material properties through real-time feedback control.

Only specific examples of implementations of certain embodiments may be described. Variations, improvements and enhancements of the disclosed embodiments and other embodiments may be made based on the disclosure of this patent document.

What is claimed is:

1. A system for manufacturing a dry electrode, comprising:
an extrusion device forming an electrode fillet by stirring or extruding electrode powder particles; and
an analysis device deriving material properties of at least a portion of the electrode fillet formed by the extrusion device,
wherein the extrusion device is controlled based on the material properties derived from the analysis device.

2. The system of claim 1, wherein the extrusion device includes an inlet introducing the electrode powder particles into an internal space, a screw member stirring or pressurizing the introduced electrode powder particles into the internal space to form the electrode fillet, and an outlet discharging the electrode fillet.

3. The system of claim 2, wherein the analysis device is connected to the outlet to introduce at least a portion of the electrode fillet, and structured to derive the material properties of the introduced electrode fillet.

4. The system of claim 1, wherein the analysis device applies at least one type of force among shear stress or normal stress to the electrode fillet, to derive the material properties of the electrode fillet.

5. The system of claim 4, wherein the analysis device includes:
a material-receiving portion into which the electrode fillet is introduced; and
a material-pressurizing portion structured to press the electrode fillet received in the material-receiving portion.

6. The system of claim 5, wherein the material-pressurizing portion is structured to advance toward the material-receiving portion to apply the normal stress to the electrode fillet and, while rotating in that state, to apply the shear stress to the electrode fillet.

7. The system of claim 1, wherein the material properties of the electrode fillet derived from the analysis device include at least one of a flow function (F.F.) value or a cohesion value of the electrode fillet.

8. The system of claim 7, wherein at least one of a temperature of the internal space of the extrusion device or RPM (rotations per minute) of a screw member provided in the extrusion device is controlled, based on the material properties.

9. The system of claim 8, wherein, when the flow function value of the electrode fillet derived from the analysis device exceeds 2.5, at least one of the temperature of the internal space of the extrusion device or the RPM of the screw member increases.

10. The system of claim 8, wherein, when the cohesion value of the electrode fillet derived from the analysis device is less than 3 kPa, at least one of the temperature of the internal space or the RPM of the screw member increases.

11. The system of claim 8, wherein, when the cohesion value of the electrode fillet derived from the analysis device exceeds 50 kPa, at least one of the temperature of the internal space or the RPM of the screw member decreases.

12. The system of claim 1, further including a roller part rolling the electrode fillet discharged from the outlet,
wherein the electrode fillet discharged from the outlet is structured to be provided, together to the roller part and the analysis device.

13. A method for manufacturing a dry electrode, comprising:
a powder particles-introducing operation of introducing electrode powder particles including a binder into an extrusion device;
a powder particles-mixing and extruding operation of stirring and compressing the introduced electrode powder particles to form an electrode fillet;
an analyzing operation of analyzing material properties of the electrode fillet; and
a control operation of controlling the extrusion device, based on the material properties derived from the analyzing operation.

14. The method of claim 13, wherein the analyzing operation includes:
a flowability-analyzing operation of analyzing whether a flow function value of the electrode fillet falls within a preset range; and
a cohesion-analyzing operation of analyzing whether a cohesion value of the electrode fillet falls within a preset range.

15. The method of claim 14, wherein the preset range of the flow function value is 2.5 or less.

16. The method of claim 14, wherein the preset range of the cohesion value is 3 kPa or more.

17. The method of claim 14, wherein the control operation feedback-controls the extrusion device when the electrode fillet does not satisfy the preset range.

18. The method of claim 17, wherein the flowability-analyzing operation increases at least one of a temperature of an internal space of the extrusion device or RPM of a screw member of the extrusion device, when the flow function value of the electrode fillet exceeds 2.5.

19. The method of claim 17, wherein the cohesion-analyzing operation increases at least one of a temperature of an internal space of the extrusion device or RPM of a screw member of the extrusion device, when the cohesion value of the electrode fillet is less than 3 kPa.

20. The method of claim 14, wherein the flowability-analyzing operation applies normal stress and shear stress to the electrode fillet, and derives the flow function value based on normal stress and shear stress when the electrode fillet begins to flow in a direction of the shear stress.
